(19) United States
(12) Patent Application Publication
(10) Pub. No.: US 2025/0047148 A1
(43) Pub. Date: Feb. 6, 2025

(54) PCB STATOR WITH INTEGRAL FERROMAGNETIC CORE

(71) Applicant: East West Manufacturing, LLC, Atlanta, GA (US)

(72) Inventors: Stephen Andrew Semidey, Woodstock, GA (US); Charles Simons, Peachtree Corners, GA (US)

(21) Appl. No.: 18/791,557

(22) Filed: Aug. 1, 2024

Related U.S. Application Data
(60) Provisional application No. 63/517,237, filed on Aug. 2, 2023.

(51) Int. Cl. H02K 1/14; H02K 1/27; H02K 3/18; H02K 9/22; H02K 15/02

(52) U.S. Cl. CPC H02K 1/14; H02K 1/27; H02K 3/18; H02K 9/22; H02K 15/02

(57) ABSTRACT

A printed circuit board (PCB)-based axial flux motor and methods of manufacturing are disclosed herein. The axial flux motor includes a printed circuit board (PCB) stator assembly having a plurality of PCB stator cores distributed about a central rotational axis, each of the PCB stator cores include at least one stator coil layer surrounding a corresponding PCB void and a stator core insert disposed in the corresponding PCB void. The axial flux motor includes one or more rotors attached to a common shaft, each rotor having at least two magnetic poles. The axial flux motor includes a frame having at least one bearing. The frame is configured to align and support the one or more rotors for rotation about the central rotational axis.

### CROSS-REFERENCE TO RELATED APPLICATIONS

This application claims the benefit of U.S. Provisional Application Ser. No. 63/517,237, filed on Aug. 2, 2023, the contents of which are incorporated herein by reference in its entirety as if fully set forth below.

### FIELD OF THE DISCLOSURE

The various embodiments of the present disclosure relate generally to axial flux motors, and to printed circuit board (PCB) stators having integral ferromagnetic cores that can enable production of low-cost motors.

### BACKGROUND

Axial flux motors have the potential to provide numerous advantages over conventional radial flux motors. For example, axial flux motors can have a higher efficiency, a smaller size, a lower weight, and/or a higher torque output in comparison with radial flux motors.

A typical axial flux motor includes a stator having multiple windings around core areas that can be used to generate alternating magnetic field normal to the face of the stator (i.e., parallel with axis of rotation), and rotor with multiple magnets disposed on the face of the rotor such that the magnetic field lines generated by the magnets are parallel with the rotation axis of the rotor, and can interact with the magnetic flux generated by the stator to provide the rotation. Multiple rotors and/or stators may be stacked onto one another along a common rotation axis, for example, to increase torque output.

Among the challenges and drawbacks associated with traditional designs in axial flux motors is the reliance on copper wire windings and/or high magnetic density permanent magnets, such as rare earth elements like neodymium, which can lead to higher costs to achieve performance targets. Furthermore, traditional wire-based windings can be difficult and expensive to manufacture. For example, traditional stators windings can be insulated from each other to allow current flow, but hand-winding introduces errors, increases costs, and limits the number of windings. Thus, hand or machine wound stator windings can be particularly problematic for axial stators, where small bending radii increase the risk of mechanical failure and reduce power density.

Another challenge associated with axial flux motors is the management of heat. Changing magnetic fields can induce eddy currents that circulate within conductive materials and generate unwanted losses and heat. The use of lamination-insulated steel layers stacks, like those used in transformers, can be used to reduce such eddy currents. However, without proper heat dissipation techniques, the magnetic properties and/or motor durability can be compromised due to heat-related stress and fatigue due to cycles of thermal expansion.

U.S. Pat. No. 11,616,423, incorporated herein as if presented in full, describes an axial field rotary energy device that utilizes a rotor that includes a magnet, and printed circuit board (PCB) “panels” for each pole/phase of the stator in which etched circuit traces can be used to define multi-turn flat coils that may be essentially stacked/layered and connected with vias. The use of such well-known PCB manufacturing techniques can be used to reduce manufacturing and materials costs. However, previous PCB-based designs can suffer from low magnetic field density, which can negatively impact performance. Additionally, the use of magnets attached to the rotor for such designs can create additional material costs, manufacturing costs, and reliability issues.

There are still needs for improved stator designs and manufacturing techniques that can utilize the benefits of the PCB-based stator while overcoming the challenges and expense associated with bulky cores and/or attached magnets.

### BRIEF SUMMARY

The disclosed technology relates to new axial-flux motor designs that address several of the previously mentioned shortcomings. Certain implementations of the disclosed technology can utilize one or more ferrite-based rotors and a PCB stator that utilizes a ferromagnetic core embedded within the PCB stator poles. In accordance with certain exemplary implementations of the disclosed technology, a material may be disposed within the voids of the stator cores on the PCB to allow for a boost in the magnetic field strength and to enable the use of lower cost permanent magnet on the rotor.

A printed circuit board (PCB)-based axial flux motor is disclosed herein. The axial flux motor includes a printed circuit board (PCB) stator assembly having a plurality of PCB stator cores distributed about a central rotational axis, each of the PCB stator cores include at least one stator coil layer surrounding a corresponding PCB void and a stator core insert disposed in the corresponding PCB void. The axial flux motor includes one or more rotors attached to a common shaft, each rotor having at least two magnetic poles. The axial flux motor includes a frame having at least one bearing. The frame is configured to align and support the one or more rotors for rotation about the central rotational axis.

In accordance with an exemplary implementation of the disclosed technology a method of manufacturing an axial flux motor having a PCB stator assembly is disclosed herein. The method includes providing a PCB stator having a plurality of PCB stator cores distributed about a hole centered on a central rotational axis, each of the PCB stator cores including at least one stator coil layer surrounding a corresponding PCB void; installing a stator core insert in the corresponding PCB void of each of the PCB stator cores; inserting a common shaft through the hole centered on the rotational axis of the PCB; attaching one or more rotors to the common shaft, each of the one or more rotors comprising at least two magnetic poles; and securing the PCB stator to a frame having at least one bearing, wherein the frame is configured to align and support the one or more rotors for rotation about the central rotational axis.

In accordance with certain exemplary implementations of the disclosed technology, an axial flux motor comprising integrated cooling fins is provided. The axial flux motor comprises a printed circuit board (PCB) stator assembly having a plurality of PCB stator cores distributed about a central rotational axis, each of the PCB stator cores comprising at least one stator coil layer surrounding a corresponding stator core; and one or more rotors attached to a common shaft. At least one of the one or more rotors comprise at least two magnetic poles comprising discrete magnets or embedded injection molded magnets, and a plurality of straight cooling fin vanes defined by gaps between the at least two magnetic poles. The axial flux motor includes a frame comprising at least one bearing, wherein the frame configured to align and support the one or more rotors for rotation about the central rotational axis.

Various example embodiments of stator core inserts are disclosed herein, for example, to increase magnetic flux and/or to reduce associated eddy currents. Various example implementations of rotor poles are also disclosed herein.

These and other aspects of the present disclosure are described below with the aid of the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the various implementations, specific embodiments are shown in the drawings. It should be understood, however, that the disclosure is not limited to the precise arrangements and instrumentalities of the embodiments shown in the drawings, and the drawings are not necessarily to scale.

FIG. 1A is an example illustration of a portion of a PCB-based stator assembly 100 including stator core inserts 108 that can be disposed in corresponding voids in the PCB, in accordance with an exemplary embodiment of the disclosed technology.

FIG. 1B is an example illustration of a snap-in stator core, as illustrated in the assembly 100 of FIG. 1, in accordance with an exemplary embodiment of the disclosed technology.

FIG. 1C is an example illustration of a rolled-up stator core that may be embedded and utilized in the stator core insert, for example to increase magnetic flux while reducing eddy currents, in accordance with certain exemplary implementations of the disclosed technology.

FIG. 1D is an example illustration of a stacked stator core that may be embedded and utilized in the stator core insert, for example to increase/concentrate the magnetic flux while reducing eddy currents, in accordance with certain exemplary implementations of the disclosed technology.

FIG. 1E is an example illustration of another stacked stator core that may be embedded and utilized in the stator core insert, for example to increase magnetic flux while reducing eddy currents, in accordance with certain exemplary implementations of the disclosed technology.

FIG. 1F is an example illustration of a through-conductor stator core that may be utilized in the stator core insert, for example to increase magnetic flux while reducing eddy currents, in accordance with certain exemplary implementations of the disclosed technology.

FIG. 1G is an example side view illustration of one of the through-conductors as illustrated in the stator core implementation shown in FIG. 1F that may be utilized in the stator core insert, for example to increase magnetic flux while reducing eddy currents, in accordance with certain exemplary implementations of the disclosed technology.

FIG. 2 depicts a 3D exploded view of portions of a dual-rotor axial flux motor, in accordance with certain exemplary implementations of the disclosed technology, where the rotors poles are made using low-cost ferromagnetic material.

FIG. 3 depicts a 3D exploded view of portions of an axial flux motor, in accordance with certain exemplary implementations of the disclosed technology, where the rotors poles are made using magnets.

FIG. 4A depicts a 3D exploded view of portions of an axial flux motor where a back-iron is utilized, in accordance with certain exemplary implementations of the disclosed technology.

FIG. 4B depicts a cross-sectional view of portions of an axial flux motor stator and back-iron, where the back-iron may be fabricated with protrusions that can be inserted into voids of the PCB, in accordance with certain exemplary implementations of the disclosed technology.

FIG. 5 depicts a 3D exploded view of portions of an example axial flux motor where the PCB may have additional thru-holes for mounting a frame and/or a back-iron, in accordance with certain exemplary implementations of the disclosed technology.

FIG. 6A depicts a 3D view of portions of an example axial flux motor, in accordance with certain exemplary implementations of the disclosed technology.

FIG. 6B depicts a cross-sectional view of the example axial flux motor as shown in FIG. 6A, in accordance with certain exemplary implementations of the disclosed technology.

FIG. 7A depicts a 3D view of an example axial flux motor, in accordance with certain exemplary implementations of the disclosed technology.

FIG. 7B depicts a top view of the example axial flux motor as shown in FIG. 7A, in accordance with certain exemplary implementations of the disclosed technology.

FIG. 7C depicts a bottom view of the example axial flux motor as shown in FIG. 7A, in accordance with certain exemplary implementations of the disclosed technology.

FIG. 8A depicts a 3D view of portions of example axial flux motor (for example, as illustrated in FIGS. 7A-7C), illustrating portions of the rotor magnets and cooling fins, in accordance with certain exemplary implementations of the disclosed technology.

FIG. 8B depicts a 3D view of portions of the example axial flux motor (for example, as illustrated in FIG. 8A, illustrating portions of the stator cores in the stacked PCBs, in accordance with certain exemplary implementations of the disclosed technology.

FIG. 9A depicts a 3D view of an example PCB-based dual-stator, single rotor axial flux motor, in accordance with certain exemplary implementations of the disclosed technology.

FIG. 9B depicts a cross-sectional view of the example PCB-based dual-stator, single rotor axial flux motor as shown in FIG. 9A, in accordance with certain exemplary implementations of the disclosed technology.

FIG. 10A depicts a 3D view of portions of the example axial flux motor (for example, as illustrated in FIGS. 9A-9B), in accordance with certain exemplary implementations of the disclosed technology.

FIG. 10B depicts a 3D view of portions of the example axial flux motor (for example, as illustrated in FIGS. 9A-9B), in accordance with certain exemplary implementations of the disclosed technology.

FIG. 11A depicts a 3D view of portions of example axial flux motor (for example, as illustrated in FIGS. 9A-9B), illustrating portions of the rotor magnets and cooling fins, in accordance with certain exemplary implementations of the disclosed technology.

FIG. 11B depicts a 3D view of portions of the example axial flux motor (for example, as illustrated in FIGS. 9A-9B), illustrating portions of stator cores in in one of the stacked PCB stators, in accordance with certain exemplary implementations of the disclosed technology.

FIG. 12 is a flow-diagram of an example method, in accordance with certain exemplary implementations of the disclosed technology.

The above-reference figures are intended to assist in understanding the example implementations of the disclosed technology, as discussed below. In some of the figures, only part of the elements are illustrated for clarity, but are not intended to limit the scope to the illustrated elements. Like reference numbers may indicate identical or functionally similar elements.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

The disclosed technology can be utilized to reduce costs and/or improve performance of an axial flux motor and to allow for the replacement of expensive permanent magnets with less expensive materials. A silicon steel core may be utilized in the stator, for example, to increase the magnetic product of the associated alternating magnetic field, which can help offset the associated performance reduction by eliminating expensive and bulky magnets.

The disclosed technology includes various implementations of a printed circuit board (PCB)-based axial flux motor that solves some of the shortcomings discussed above.

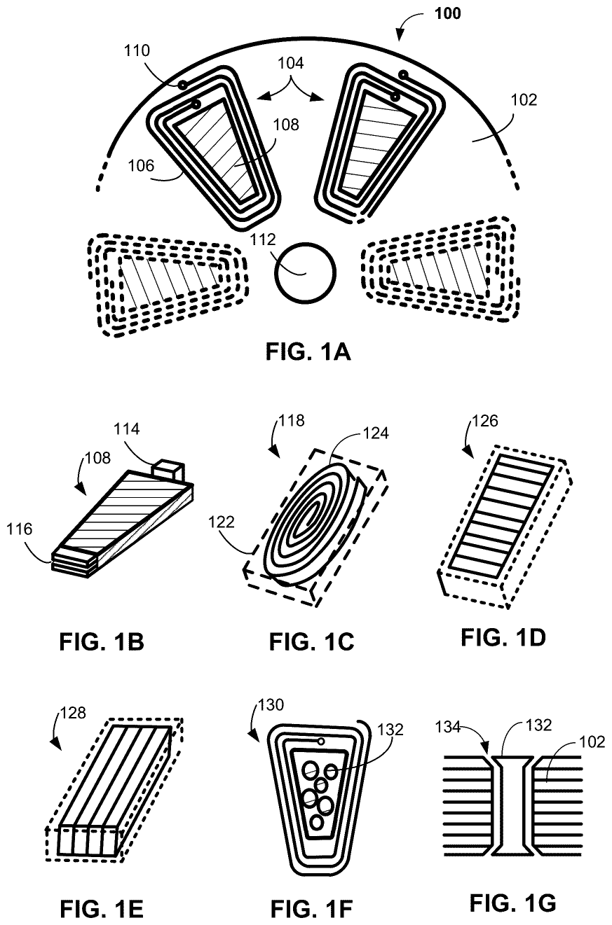

FIG. 1A is an example top-view illustration of a portion of one layer of a stator assembly 100 formed using a PCB 102, in which “windings” of the stator cores 104 may be formed using circuit-trace-based spiral-like stator windings 106 around central thru-voids in the PCB 102. The windings 106 may be formed on the PCB 102, for example, using standard printed circuit board manufacturing techniques. In certain implementations, each end of each stator winding 106 conductors may be routed to driver circuitry (not shown) that may be used to induce magnetic fields via current running through the trace windings 106. In certain implementations, vias 110 may be utilized to route such driver current to the trace windings 106 from another side or layer of the PCB 102 and/or to connect to additional co-aligned stator cores defined in different layers of the PCB and/or via stacked PCBs.

In accordance with certain exemplary implementations of the disclosed technology, the thru-voids in the PCB 102 can be machined either before or after etching the circuit traces 106 to facilitate disposing stator core inserts 108 in the corresponding thru-voids in the PCB, for example, to enable boosting/concentrating of the magnetic flux generated by the PCB stator assembly 100. In certain implementations, the stator core inserts 108 can include interior space that may be filled using silicon steel or other soft ferromagnetic material to provide a core that may increase the magnetic flux strength while reducing eddy currents, as will be discussed with reference to FIGS. 1C-1G below.

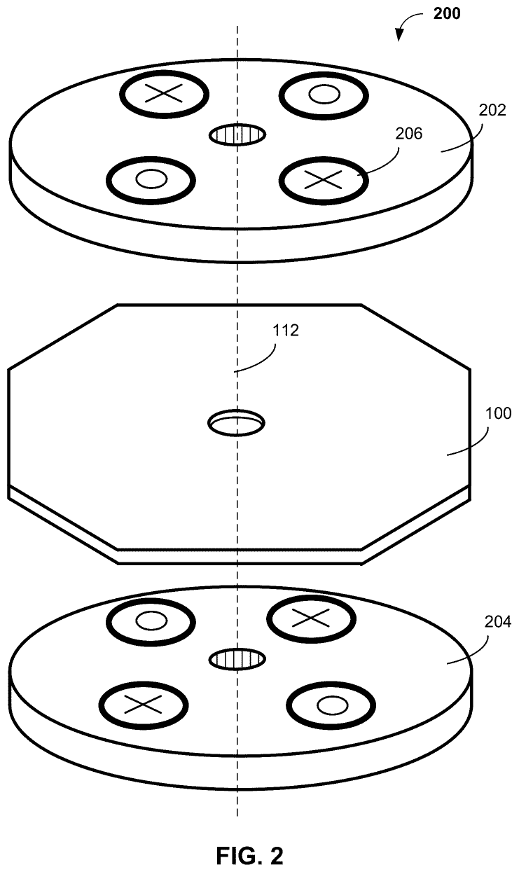

As shown in FIG. 1A, the individual cores 104 (including the windings 106 and stator core inserts 108) of the assembly 100 may be of similar shape and positioned about a central axis 112 of the stator assembly 100 approximately an equal distance from the axis 112. In certain implementations, a central trough hole may be defined in the PCB 102 about the axis 112 to accommodate a rotor shaft. It should be appreciated that FIG. 1A illustrates approximately a half of a 6-pole stator assembly, but any (even) number of poles may be utilized. It should also be appreciated that the outer boundary shape of the PCB 102 can be circular (as shown in FIG. 1A) or may take on any convenient shape needed (as illustrated in FIGS. 2-5). In certain implementations, motor driver circuitry, control circuitry, etc., may occupy a common PCB 102 with the stator cores 104.

It should also be appreciated that the utilization of the stator core inserts 108 in the stator may provide many advantages over designs that utilize insertable cores in a rotor because the stator is stationary, and not subject to the same rotational forces as experience by a rotor. Thus, in contrast to designs that may utilize insertable cores in a rotor, the disclosed technology may allow for relaxed tolerances on the requirements for exact equidistant positioning and/or requirements for exact equal weights of the inserts (for balancing to avoid vibrations). Furthermore, in certain implementations, interference fitting or other “snap-in” techniques may be utilized in the disclosed technology (as will be explained below) to secure the inserts 108 in the stator cores 104 while relaxing tolerances of a thermal expansion match with the PCB 102.

FIG. 1B is an example illustration of a stator core insert 108, as illustrated in the assembly 100 of FIG. 1. In certain implementations, the stator core insert 108 may be produced in the form of a snap-in component that can be inserted into the thru-void in the PCB 102, for example, in a central portion surrounded by the trace windings 106. In an example implementation, the stator core insert 108 may have a (horizontal) notch 116 fabricated in a first end that may lock into a corresponding protrusion machined on the PCB 102. The stator core insert 108 may include a deformable snap latch 114 on a second end to secure the stator core insert 108 within the thru-void in the PCB 102. In other implementations (not shown), the stator core insert 108 may have a (horizontal) protrusion on the first end that may engage with a corresponding notch in the PCB 102 to secure the first end to the PCB 102. In other example implementations, the stator core insert 108 may be molded into the thru-void in the PCB 102 while being held into position, for example, to further secure the stator core insert 108 into the thru-void in the PCB 102 or to eliminate the need for the snap-in features.

In certain implementations, the snap-in component can be manufactured by an overmolding process. Overmolding, for example, can include a process in which a material (such as a plastic) is molded over another part, which may also be molded. In certain implementations, the overmolding can be a two-shot process that involves injecting two different materials to form a substrate and an overmold.

In accordance with certain exemplary implementations of the disclosed technology, a soft magnetic composite (SMC) powder may be utilized to fabricate the stator core insert (and/or poles of the rotor as will be discussed below). SMC material, for example, can provide a lower cost alternative to stacked laminations. SMC's can be created by coating individual particles of iron with an insulation material. In certain implementations, injection molded magnets formed from dense magnetic powders blended with a variety of polymer base materials as a binder may be utilized. In certain implementations, overmolding may be utilized. By providing an insulation prior to forming a stator core insert 108 (and/or rotor pole, as will be discussed below) the result is a component that can have high-resistivity and very little eddy current losses. Coupling the material capabilities with the design freedom of conventional powder metallurgy, the various components of the axial flux motor, can be designed to guide the magnetic flux taking advantage of 3D vertical architecture in accordance with certain exemplary implementations of the disclosed technology.

FIG. 1C is an example illustration of another embodiment of a stator core 118 that may be utilized to form a stator core insert 108 using a rolled-up a silicon steel strip 124, for example, that that may be embedded in an overmold 122 and utilized in the stator core insert 108 to increase magnetic flux while reducing eddy currents, in accordance with certain exemplary implementations of the disclosed technology. Certain implementations may utilize a coiled segment of transformer steel (oriented or non-oriented material or other soft magnetic composite material or like materials.

FIG. 1D is an example illustration of a stacked stator core 126 that may be embedded and utilized in the stator core insert 108, for example to increase/concentrate the magnetic flux while reducing eddy currents, in accordance with certain exemplary implementations of the disclosed technology. Certain implementations of the disclosed technology may utilize a stack of laminated transformer steel material for this implementation.

FIG. 1E is an example illustration of another stacked stator core 128 that may be embedded and utilized in the stator core insert 108, for example to increase magnetic flux while reducing eddy currents, in accordance with certain exemplary implementations of the disclosed technology. Certain implementations of the disclosed technology may utilize a stack of laminated transformer steel material for this implementation.

FIG. 1F is a top view illustration, and FIG. 1G is a cutaway side view illustration of a through-conductor stator core 132 that may be utilized for the stator core, for example to increase magnetic flux while reducing eddy currents. In certain implementations, a plurality of elongated conductors 132 may be fed through corresponding through-holes 134 in the PCB 102 for example, within a central portion and surrounded by the windings 106. In certain implementations, the elongated conductors 132 can be steel rivets, screws, cylinders, or the like. In certain implementations, a plurality of elongated conductors 132 may be fed through and secured in corresponding through-holes 134 of a separate insert that can be inserted into the thru-void in the PCB 102.

FIG. 2 is 3D exploded view illustration of portions of an axial flux motor 300, in accordance with certain exemplary implementations of the disclosed technology. In this illustration, the individual cores and components of the PCB stator assembly 100 (as discussed above with reference to FIG. 1), plus the rotor shaft and the mounting frame and are all omitted for clarity. As illustrated, the axial flux motor 300 can include a first rotor 202 disposed on a first side of the PCB stator assembly 100, and a second rotor 204 disposed on a second side of the PCB stator assembly 100. FIG. 2 illustrates the alignment of the rotors 202, 204 with the central rotational axis 112 of the PCB stator assembly 100. In accordance with certain implementations of the disclosed technology, magnetic fields generated by the PCB stator assembly 100 may interact with magnetically charged poles 206 defined in the rotors 202, 204 to provide rotational torque on the rotors 202, 204 relative to the PCB stator assembly 100.

In accordance with certain exemplary implementations of the disclosed technology, the rotor poles 200 may be made by injection molded magnets made from particles of hard magnetic material. For example, injection molded magnets for the rotor poles 200 may be made from dense magnetic powders blended with a variety of polymer base materials as a binder. Depending on the combination of magnetic material and polymer selected, a wide range of final material properties and complex shapes are possible. The injection molded magnets may form simple shapes to very complex shapes. Depending on the magnetic material, the parts may require magnetic orientation during the injection molding process to optimize the magnetic properties. In accordance with certain exemplary implementations of the disclosed technology, injection molded magnets can be utilized in an overmolding process to define corresponding regions of poles 206 in the rotors 202, 204. In accordance with certain exemplary implementations of the disclosed technology, an overmold may be utilized to define and/or produce the other regions of rotor(s) so that the result is an integrated part that does not suffer from negative issues that can be associated with inserts attached to such rotating parts.

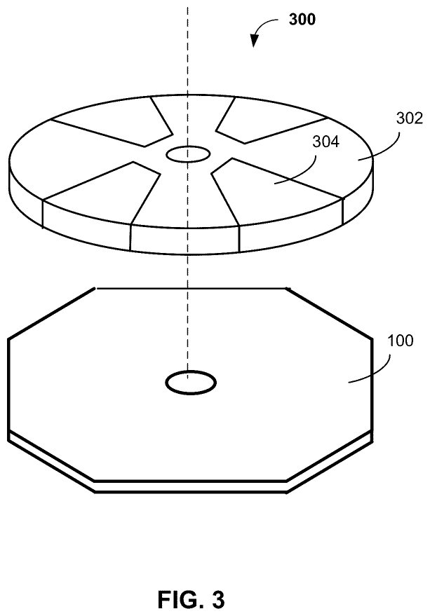

FIG. 3 depicts a 3D exploded view of portions of a single rotor 302 axial flux motor 300, in accordance with certain exemplary implementations of the disclosed technology, where the poles 304 of the rotor 302 may be made using magnets. In this illustration, the individual cores and components of the PCB stator assembly 100 (as discussed above with reference to FIG. 1), plus the rotor shaft and the mounting frame and are all omitted for clarity. In accordance with certain exemplary implementations of the disclosed technology, one or more of the poles 304 of the rotor may comprise embedded or attached permanent magnets. In accordance with certain exemplary implementations of the disclosed technology, an additional rotor (not shown) may be utilized in this design, similar to that shown in FIG. 2.

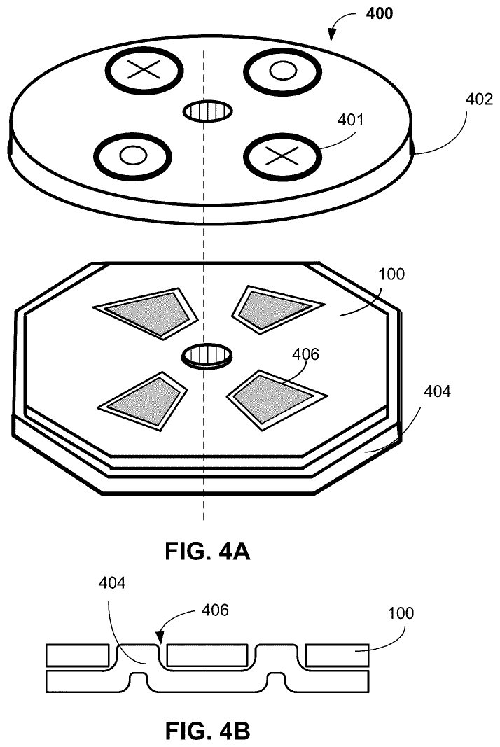

FIG. 4A depicts a 3D exploded view of portions of an axial flux motor 400 where a back-iron 404 may be utilized and attached to the PCB stator assembly 100, for example, to further concentrate the magnetic field lines within the material of the back-iron 404 to increase the magnetic flux. In this illustration, the individual cores of the PCB stator assembly 100 (as discussed above with reference to FIG. 1), the rotor shaft, and the mounting frame and are all omitted for clarity, however, additional PCB voids 406 are shown to aid in understanding of this example implementation.

As illustrated in FIG. 4A a single rotor 402 may be utilized in this embodiment of the axial flux motor 400, where the poles 401 may be ferrite-based and/or fabricated as discussed above, for example, by either utilizing an injection molded ferrite material (as discussed above), or by utilizing magnets. In accordance with certain exemplary implementations of the disclosed technology, the steel back-iron 404 may be affixed to the PCB stator assembly 100 so that it is generally not rotating with respect to the PCB stator assembly 100. In certain implementations, the back-iron 404 can either be composed of a solid plate in close proximity to the PCB stator assembly 100. In certain implementations, the back-iron 404 can have drawn reliefs and/or protrusions to provide steel material within the voids 406 of the PCB stator assembly 100. In accordance with certain exemplary implementations of the disclosed technology, this embodiment could allow for a single rotor 402, which may provide a lower cost solution.

FIG. 4B depicts a cross-sectional view of portions of an axial flux motor PCB stator assembly 100 and back-iron 404, as discussed above and illustrated in FIG. 4A, where the back-iron 404 may be fabricated with protrusions that can be inserted into the voids 406 of the PCB stator assembly 100, in accordance with certain exemplary implementations of the disclosed technology.

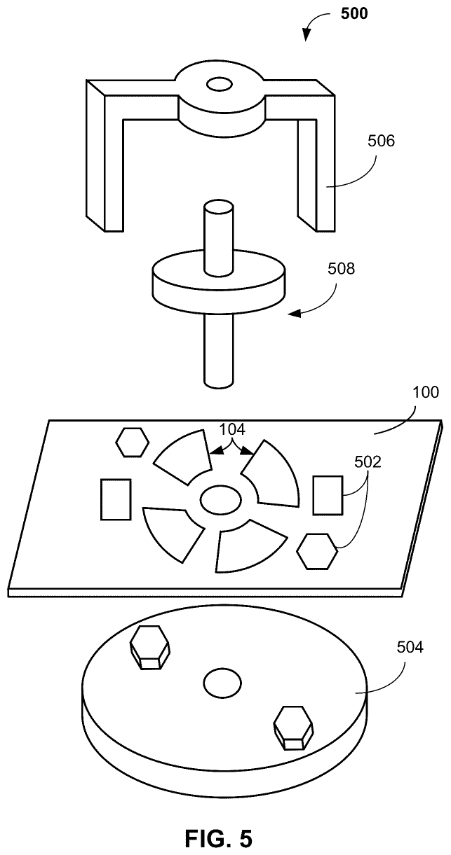

FIG. 5 depicts a 3D exploded view of portions of an example axial flux motor 500 where the PCB stator assembly 100 may have additional thru-holes 504 for mounting a frame/bearing assembly 506, for example, to secure/support one end of the rotor/shaft assembly 508 and/or a back-iron 504 and/or associated bearings to secure/support the other end of the rotor/shaft assembly 508, in accordance with certain exemplary implementations of the disclosed technology. This embodiment may enable rapid construction of an axial flux motor attached to a PCB-based stator assembly 100, as discussed herein.

In certain implementations, the attachment of the frame/bearing assembly 506 and/or the back iron 504 and associated components to PCB-based stator assembly 100 may facilitate fabrication of a low-cost single motor product and/or as a PCB-mounted motor within a greater PCB assembly. This design allows for low-cost micromotors, for example, to be placed directly on a PCB without requiring the expense of additional mounting hardware. This design also may simplify the positioning/alignment of the various motor components. The implementations discussed above in reference to FIG. 5 may be utilized with the other implementations discussed herein.

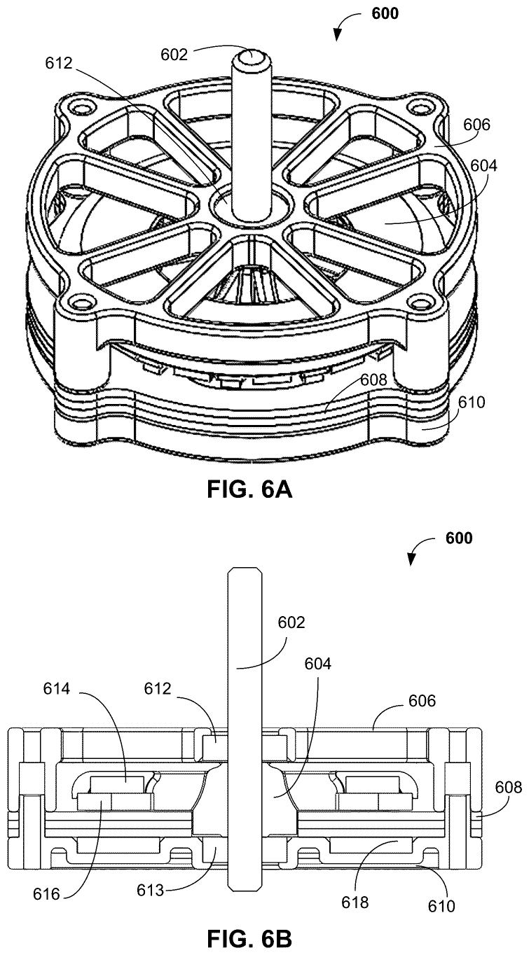

FIGS. 6A-11B will now be discussed below to illustrate how the disclosed technology may be utilized in the design and/or production of low-cost axial flux motors that utilize a PCB-based stator assembly.

FIG. 6A depicts a 3D perspective view of portions of an example axial flux motor 600 in accordance with certain exemplary implementations of the disclosed technology. In certain implementations, the motor 600 can include a shaft 602 attached to a rotor 604. A front frame 606 may be attached to one or more layers of a PCB stator assembly 608 and to a rear frame 610. The top or front portion of the shaft 602 may be attached to an inner portion of a top bearing 612, which may have an outer portion attached to the front frame 606, for example, to enable rotation of the rotor 604/shaft 602 while providing radial stability and/or positioning of the rotor 604 with respect to the PCB stator assembly 608.

FIG. 6B depicts a cross-sectional side view of the example axial flux motor 600 as shown in FIG. 6A, in accordance with certain exemplary implementations of the disclosed technology. In this example implementation, a bottom or rear portion of the shaft 602 may be attached to an inner portion of a bottom bearing 613, which may have an outer portion attached to the rear frame 610, for example, to further enable rotation of the rotor 604/shaft 602 while providing radial stability and/or positioning of the rotor 604 with respect to the PCB stator assembly 608.

According to certain example implementations, and as depicted in FIG. 6B, a rotor back iron 614 and/or a stator back iron 618 may be utilized, for example, to increase the magnetic flux. In accordance with certain exemplary implementations of the disclosed technology, magnets 616 and/or embedded injection molded magnet regions may be utilized for the poles of the rotor assembly.

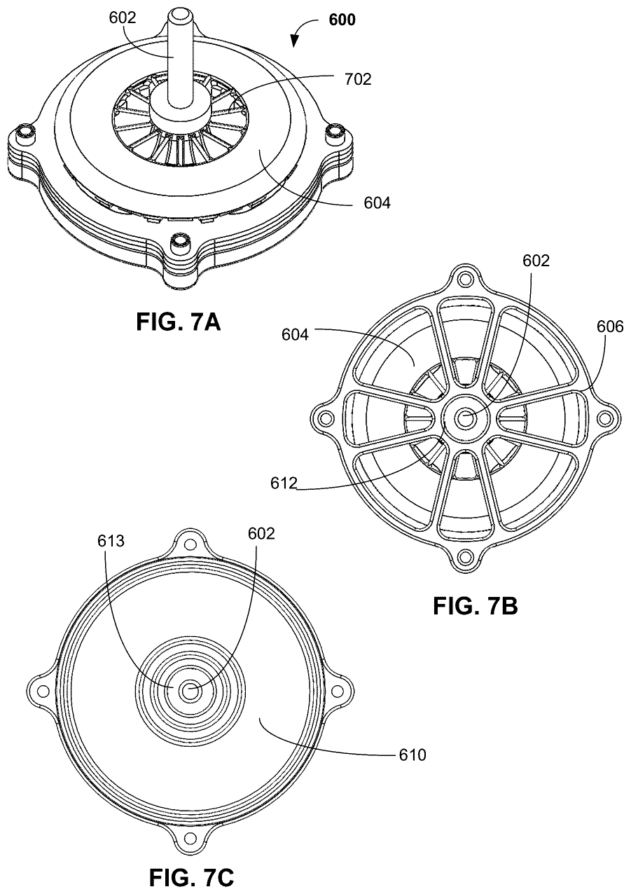

FIG. 7A depicts a 3D view of the example axial flux motor 600 (as depicted in FIGS. 6A and 6B) with the front frame 606 omitted for clarity, in accordance with certain exemplary implementations of the disclosed technology. In accordance with certain implementations of the disclosed technology, cooling fins 702 may be integrated into the rotor assembly 604, which can include the shaft 602. FIG. 7B depicts a top view of the example axial flux motor 600 as shown in FIG. 7A and FIGS. 6A-6B, in accordance with certain exemplary implementations of the disclosed technology, where front frame 606 is illustrated. FIG. 7C depicts a bottom view of the example axial flux motor 600 as shown in FIGS. 7A-7B and FIGS. 6A-6B, in accordance with certain exemplary implementations of the disclosed technology.

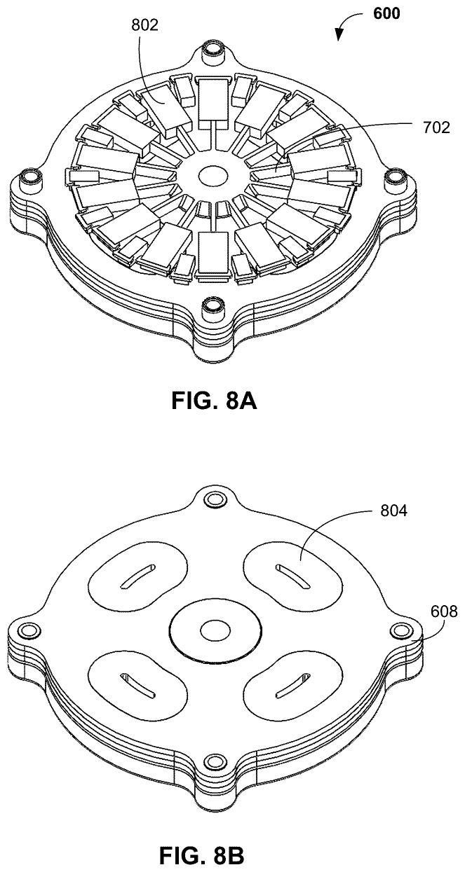

FIG. 8A depicts a 3D view of portions of example axial flux motor 600 (for example, as illustrated in FIGS. 6A-6B and 7A-7C, illustrating portions of the rotor poles 802 and cooling fins 702, in accordance with certain exemplary implementations of the disclosed technology. In certain implementations, the rotor poles 802 may be discreet magnets. In certain implementations, the rotor poles 802 may be made from attached magnets and/or embedded injection molded magnets, as discussed above. In certain implementations, the cooling fins can include straight fan vanes created by gaps between the rotor poles 802. In certain implementations, the advantage of having straight fan vanes allows cooling when the rotor is rotating in either direction. In certain implementations, the fan vanes may be manufactured by molding directly into injection molded magnet material.

FIG. 8B depicts another 3D view of portions of the example axial flux motor 600 (for example, as illustrated in FIGS. 6A-6B, 7A-7C and 8A, illustrating portions of the stator cores 804 in the PCB stator assembly 608, which can include stacked PCBs, as discussed above and in accordance with certain exemplary implementations of the disclosed technology.

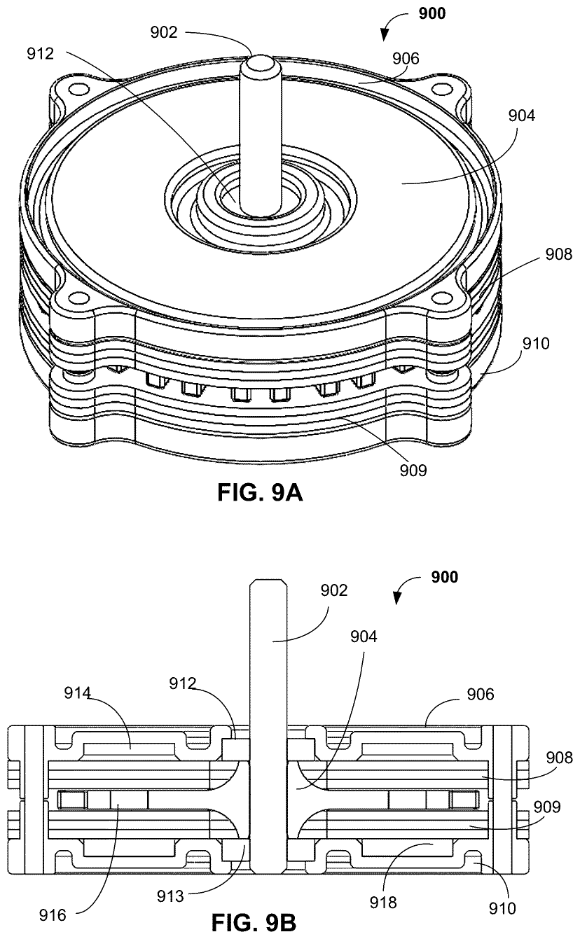

FIG. 9A depicts a 3D perspective view of portions of an example dual-stator, single rotor axial flux motor 900 in accordance with certain exemplary implementations of the disclosed technology. In certain implementations, the motor 900 can include a shaft 902 attached to a rotor 904. A front frame 906 may be attached to one or more layers of a PCB top stator assembly 908, a PCB bottom stator assembly 909, and to a rear frame 910. The top or front portion of the shaft 902 may be attached to an inner portion of a top bearing 912, which may have an outer portion attached to the front frame 906, for example, to enable rotation of the rotor 904/shaft 902 while providing radial stability and/or positioning of the rotor 904 with respect to the PCB top stator assembly 908 and/or the PCB bottom stator assembly 909.

FIG. 9B depicts a cross-sectional view of the example PCB-based dual-stator, single rotor axial flux motor 900 as shown in FIG. 9A, in accordance with certain exemplary implementations of the disclosed technology. In this example implementation, a bottom or rear portion of the shaft 902 may be attached to an inner portion of a bottom bearing 913, which may have an outer portion attached to the rear frame 910, for example, to further enable rotation of the rotor 904/shaft 902 while providing radial stability and/or positioning of the rotor 904 with respect to the PCB top stator assembly 908 and/or the PCB bottom stator assembly 909.

According to certain example implementations, and as depicted in FIG. 9B, a rotor back iron 914 and/or a stator back iron 918 may be utilized, for example, to increase the magnetic flux. In accordance with certain exemplary implementations of the disclosed technology, magnets 916 and/or embedded injection molded magnets may be utilized for the poles of the rotor assembly.

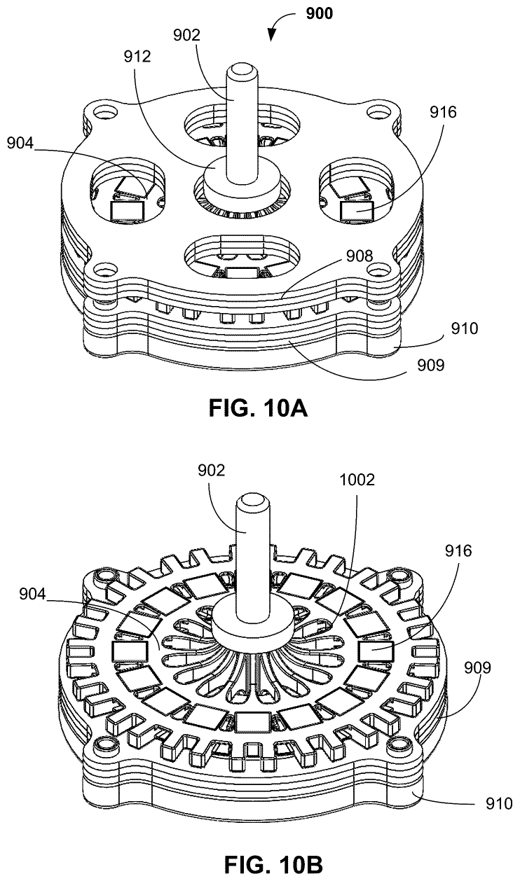

FIG. 10A depicts a 3D perspective view of portions of example PCB-based dual-stator, single rotor axial flux motor 900 as shown in FIGS. 9A-9B, in accordance with certain exemplary implementations of the disclosed technology, with like reference numbers as discussed above. The top frame has been omitted in FIG. 10A for clarity.

FIG. 10B depicts a 3D perspective view of portions of an example PCB-based dual-stator, single rotor axial flux motor 900 as shown in FIGS. 9A-9B and 10A in accordance with certain exemplary implementations of the disclosed technology, with like reference numbers as discussed above. In this example implementation, cooling fin vanes 1002 may be created by gaps between rotor poles 916. In certain implementations, the rotor poles 916 may be discreet magnets. In certain implementations, the rotor poles 916 may be made from attached magnets and/or embedded injection molded magnets, as discussed above. In certain implementations, the cooling fin vanes 1002 may be manufactured by molding directly into injection molded magnet material.

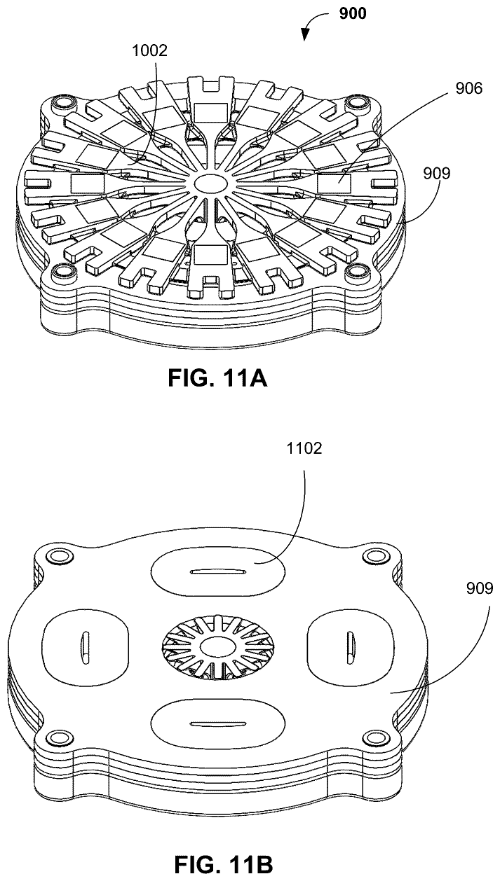

FIG. 11A depicts a 3D perspective view of portions of the example PCB-based dual-stator, single rotor axial flux motor 900 as shown in FIGS. 9A-9B and 10A-10B in accordance with certain exemplary implementations of the disclosed technology, with like reference numbers as discussed above. Certain components, such as the top frame, shaft, and top PCB stator assembly have been removed in this figure for clarity.

FIG. 11A depicts a 3D perspective view of portions of the example PCB-based dual-stator, single rotor axial flux motor 900 as shown in FIGS. 9A-9B and 10A-10B in accordance with certain exemplary implementations of the disclosed technology, illustrating portions of the stator cores 1102 in the PCB bottom stator assembly 909, which can include stacked PCBs, as discussed above and in accordance with certain exemplary implementations of the disclosed technology. Certain components, such as the top frame, rotor, shaft, and top PCB stator assembly have been removed in this figure for clarity.

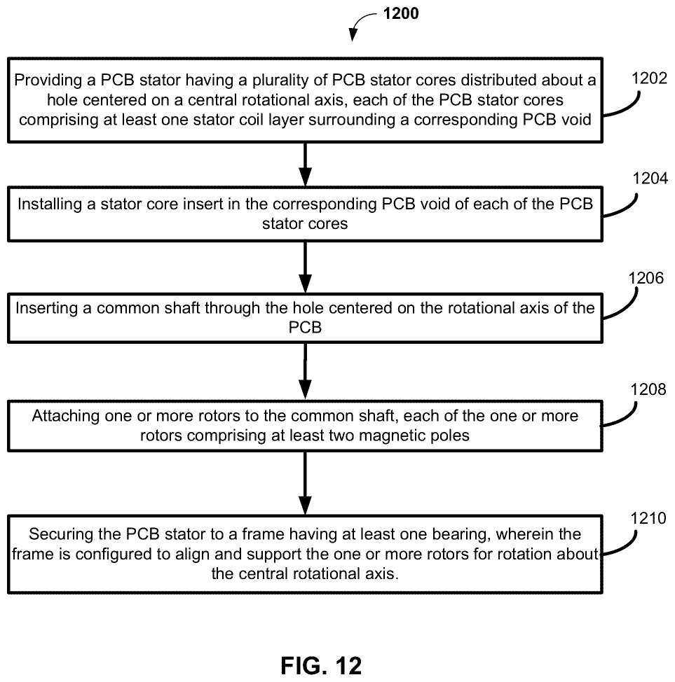

FIG. 12 is a flow-diagram of an example method 1200 of manufacturing an axial flux motor having a PCB-based stator assembly, in accordance with certain exemplary implementations of the disclosed technology. In block 1202, the method 1200 includes providing a PCB stator having a plurality of PCB stator cores distributed about a hole centered on a central rotational axis, each of the PCB stator cores comprising at least one stator coil layer surrounding a corresponding PCB void. In block 1204, the method 1200 includes installing a stator core insert in the corresponding PCB void of each of the PCB stator cores. In block 1206, the method 1200 includes inserting a common shaft through the hole centered on the rotational axis of the PCB. In block 1208, the method 1200 includes attaching one or more rotors to the common shaft, each of the one or more rotors comprising at least two magnetic poles. In block 1210, the method 1200 includes securing the PCB stator to a frame having at least one bearing, wherein the frame is configured to align and support the one or more rotors for rotation about the central rotational axis.

Certain implementations of the disclosed technology an further include defining one or more snap-in features in each of the PCB stator cores to secure each stator core insert in the corresponding PCB void of each of the PCB stator cores.

In certain implementations, defining the one or more snap-in features can include one or more of a notch and a latch configured to engage with corresponding portions of the PCB stator core.

Certain implementations of the disclosed technology can further include forming the stator core insert by coiling and overmolding a strip of steel.

Certain implementations of the disclosed technology can include forming the stator core insert by overmolding a multi-layer steel core.

In certain implementations, the one or more rotors can include an integrated cooling fan comprising a plurality of vanes.

Certain implementations of the disclosed technology can include electrically connecting a driver circuit to pairs of the PCB stator cores.

In certain implementations, rotor poles and/or stator cores may be made using a soft magnetic composite (SMC). SMC material, for example, can be utilized in an overmolding process to selectively embed SMC powder in the corresponding part.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

What is claimed is:

1. An axial flux motor, comprising:
a printed circuit board (PCB) stator assembly having a plurality of PCB stator cores distributed about a central rotational axis, each of the PCB stator cores comprising:
at least one stator coil layer surrounding a corresponding PCB void; and
a stator core insert disposed in the corresponding PCB void;
one or more rotors attached to a common shaft, each rotor comprising at least two magnetic poles; and
a frame comprising at least one bearing, wherein the frame configured to align and support the one or more rotors for rotation about the central rotational axis.

2. The axial flux motor of claim 1, wherein one or more of the PCB stator cores comprise a snap-in feature configured to secure a stator core insert within the PCB void.

3. The axial flux motor of claim 2, wherein the snap-in feature comprises one or more of a notch and a latch configured to engage with corresponding portions of the PCB stator core.

4. The axial flux motor of claim 1, wherein the stator core insert is configured to increase magnetic flux of the corresponding PCB stator core.

5. The axial flux motor of claim 1, wherein the stator core insert comprises a coiled steel core.

6. The axial flux motor of claim 1, wherein the stator core insert comprises a multi-layer steel core.

7. The axial flux motor of claim 1, wherein the stator core insert comprises an array of isolated thru conductors oriented parallel to the central rotational axis.

8. The axial flux motor of claim 1, wherein the stator core insert is configured to reduce eddy currents.

9. The axial flux motor of claim 1, wherein the one or more rotors comprise an integrated cooling fan comprising a plurality of vanes.

10. The axial flux motor of claim 1, wherein the at least one stator coil layer of the PCB stator cores comprises one or more vias configured to electrically communicate with a separate PCB layer.

11. The axial flux motor of claim 1, wherein each of the PCB stator cores comprising a plurality aligned of stator coil layers.

12. The axial flux motor of claim 1, further comprising a back-iron configured to form a return path of magnetic flux generated by the PCB stator assembly.

13. The axial flux motor of claim 1, wherein the at least two magnetic poles of the rotor comprise one or more of a magnet and an injection molded magnet.

14. A method of manufacturing an axial flux motor having a printed circuit board (PCB) based stator assembly, the method comprising:
providing a PCB stator having a plurality of PCB stator cores distributed about a hole centered on a central rotational axis, each of the PCB stator cores comprising at least one stator coil layer surrounding a corresponding PCB void;
installing a stator core insert in the corresponding PCB void of each of the PCB stator cores;
inserting a common shaft through the hole centered on the rotational axis of the PCB;
attaching one or more rotors to the common shaft, each of the one or more rotors comprising at least two magnetic poles; and
securing the PCB stator to a frame having at least one bearing, wherein the frame is configured to align and support the one or more rotors for rotation about the central rotational axis.

15. The method of claim 14, further defining one or more snap-in features in each of the PCB stator cores to secure each stator core insert in the corresponding PCB void of each of the PCB stator cores.

16. The method of claim 15, wherein defining the one or more snap-in feature comprises one or more of a notch and a latch configured to engage with corresponding portions of the PCB stator core.

17. The method of claim 14, further comprising forming the stator core insert by coiling an overmolding a strip of steel.

18. The method of claim 14, further comprising forming the stator core insert by overmolding a multi-layer steel core.

19. The method of claim 14, wherein the one or more rotors comprise an integrated cooling fan comprising a plurality of vanes.

20. The method of claim 14, further comprising electrically connecting a driver circuit to pairs of the PCB stator cores.

21. An axial flux motor comprising integrated cooling fins, comprising:
a printed circuit board (PCB) stator assembly having a plurality of PCB stator cores distributed about a central rotational axis, each of the PCB stator cores comprising at least one stator coil layer surrounding a corresponding stator core; and
one or more rotors attached to a common shaft, wherein at least one of the one or more rotors comprise:
at least two magnetic poles comprising discrete magnets or embedded injection molded magnets; and
a plurality of straight cooling fin vanes defined by gaps between the at least two magnetic poles; and
a frame comprising at least one bearing, wherein the frame configured to align and support the one or more rotors for rotation about the central rotational axis.
